(19) United States
(12) Patent Application Publication
(10) Pub. No.: US 2009/0066246 A1
(43) Pub. Date: Mar. 12, 2009

(54) Display device having electron emission sources

(76) Inventor: Sang-Hun Jang, Suwon-si (KR)

Correspondence Address: ROBERT E. BUSHNELL & LAW FIRM, 2029 K STREET NW, SUITE 600, WASHINGTON, DC, 20006-1004, US

(21) Appl. No.: 12/230,595

(22) Filed: Sep. 2, 2008

(30) Foreign Application Priority Data
Sep. 12, 2007 (KR) 10-2007-0092593

(51) Int. Cl. H01J 17/02

(52) U.S. Cl. 313/581

(57) ABSTRACT

Provided is a display device having electron emission sources. The display device includes first and second substrates which face each other at a predetermined interval and are combined so as to form an internal space, a plurality of first electrodes which are disposed between the first and second substrates, a plurality of second electrodes which are disposed on the first electrodes, an insulation layer which is disposed between the first and second electrodes, a plurality of electron emission sources each of which is formed in one of the electron emission holes that are formed by perforating the second electrodes and the insulating layer, and a gas which is injected into the internal space. Each of the second electrodes includes a second main electrode, a second auxiliary electrode, and a resistance unit which connects the second main electrodes to the second auxiliary electrodes.

### CLAIM OF PRIORITY

This application makes reference to, incorporates the same herein, and claims all benefits accruing under 35 U.S.C. §119 from an application for DISPLAY DEVICE HAVING ELECTRON EMISSION SOURCES earlier filed in the Korean Intellectual Property Office on 12 Sep. 2007 and there duly assigned Serial No. 10-2007-0092593.

### BACKGROUND OF THE INVENTION

1. Field of the Invention

The present invention relates to a display device, and more particularly, to a display device having electron emission sources, the structure of which is improved in order to prevent a malfunction of an electrode line from being generated by a dielectric breakdown.

2. Description of the Related Art

Conventionally, display devices that display an image by using electron emission sources are flat display devices that include electron emission sources formed on a first substrate, an emission layer formed on a second substrate, and thus, electrons, which are emitted from the electron emission sources, collide against the emission layer so as to display an a predetermined image from the emission of the collision.

A display device, using electron emission sources, operates by using a hot cathode method or a cold cathode method. Field emission display devices (FEDs) that use the cold cathode method are field emitter (FE) type FEDs, metal-insulator-metal (MIM) type FEDs, metal-insulator-semiconductor (MIS) type FEDs, and surface conduction emission (SCE) type FEDs.

A FED includes electron emission sources formed of a material that emits electrons if an electric field is applied, and electrodes for controlling emission of the electrons, and thus, the FED is able to display a predetermined image. The quality of the FED is greatly affected by the above-described characteristic of the electron emission sources.

However, in a conventional FED, when a voltage is applied to an electrode in order to induce electrons to be emitted from electron emission sources, if a defective cell is included in a pixel, a malfunction of a whole electrode line may be caused by a dielectric breakdown.

### SUMMARY OF THE INVENTION

The present invention provides a display device having electron emission sources, the structure of which is improved so that a main electrode unit is connected to an auxiliary electrode unit by a resistance unit and a current source of a defective cell is blocked due to the breaking of the resistance unit, which functions as a fuse, if an over-current flows through the defective cell.

According to an aspect of the present invention, there is provided a display device having an electron emission source, the display device including a first substrate, and a second substrate facing the first substrate, a first electrode disposed between the first and second substrates, a second electrode disposed between the first electrode and the first substrate, an insulation layer disposed between the first and second electrodes and having an electron emission hole, an electron emission source formed inside the electron emission hole, and a gas filling a space formed between the first and second substrates. The second electrode comprises a second main electrode, a second auxiliary electrode, and a resistance unit connecting the second auxiliary electrode to the second main electrode. The second electrode has an opening that is aligned with the electron emission hole. The electron emission source emits electrons.

The opening may be formed on the second main electrode, and the second auxiliary electrode may be disposed in the opening.

The resistance units may be formed in at least one region between the second main electrode and the second auxiliary electrode so as to connect the second main electrode to the second auxiliary electrode.

A region where the second electrode crosses the first electrode defines a sub-pixel, and one or more electron emission holes may be formed in the sub-pixel.

The first electrode may be a data electrode which is disposed on an inner surface of the second substrate and extends in a direction, and the second electrode may be a scan electrode which extends in another direction crossing the first electrode. The display device may include a third electrode formed on an inner surface of the first substrate as an anode electrode.

The electron emission sources may includes a material selected from a group consisting of carbon nano tubes (CNTs), graphite, graphite nano fibers, diamond, and silicon nano wires.

The gas may include a material selected from a group consisting of xenon (Xe), nitrogen (N₂), heavy hydrogen, carbon dioxide (CO₂), a hydrogen (H) gas, carbon monoxide (CO₁), and krypton (Kr).

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings in which like reference symbols indicate the same or similar components, wherein:

FIG. 1 is a cross-sectional view of a display device having an electron emission source;

FIG. 2 is a schematic structural view of a sub-pixel of the display device illustrated in FIG. 1;

FIG. 3 is a partial perspective view of a display device having electron emission sources, according to an embodiment of the present invention;

FIG. 4 is a magnified cross-sectional view of the display device which is illustrated in FIG. 3 and which is taken along a line IV-IV, according to an embodiment of the present invention;

FIG. 5 is a top view of an electrode unit of the display device illustrated in FIG. 4, according to an embodiment of the present invention; and

FIG. 6 is a magnified cross-sectional view of the display device illustrated in FIG. 3, after the electrode unit illustrated in FIG. 4 is broken, according to an embodiment of the present invention.

### DETAILED DESCRIPTION OF THE INVENTION

Hereinafter, the present invention will be described in detail by explaining embodiments of the invention with reference to the attached drawings. Like reference numerals denote like elements in the drawings.

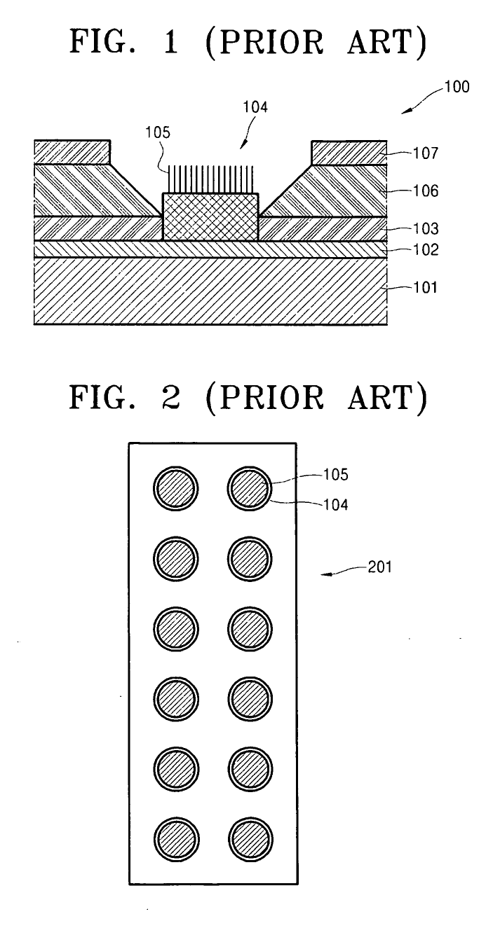

FIG. 1 is a cross-sectional view of a display device 100 having an electron emission source 105. Referring to FIG. 1, on a substrate 101 of the display device 100, a transparent electrode 102 functioning as a data electrode and a first metal electrode 103 that is electrically connected to the transparent electrode 102 are sequentially patterned. An electron emission source 105 is formed in a plurality of electron emission holes 104, and a second metal electrode 107 is patterned on the first metal electrode 103 so as to function as a scan electrode and an insulation layer 106 is formed between the first metal electrode 103 and the second metal electrode 107.

Although not shown in FIG. 1, an emission layer is formed on another substrate facing the substrate 101 and gas components generating ultraviolet light are included between the substrate 101 and the other substrate.

FIG. 2 is a schematic structural view of a sub-pixel 201 of the display device 100 illustrated in FIG. 1. Referring to FIG. 2, the sub-pixel 201 includes the electron emission holes 104 and the electron emission source 105 is formed respectively in each of the electron emission holes 104.

However, the electron emission source 105 is formed of a paste type material and thus may not be evenly formed in the electron emission holes 104 of the sub-pixel 201. Accordingly, although the same electrical potential is applied to the second metal electrode 107 illustrated in FIG. 1, current may excessively or insufficiently flow in the electron emission holes 104.

In this case, if one end of the electron emission source 105 of one of the electron emission holes 104 is closely disposed to the second metal electrode 107, an arcing phenomenon occurs due to electric field concentration. Accordingly, although an electrical potential is applied to the second metal electrode 107, a large amount of current may be concentrated on a predetermined defective cell and the electrical potential may not be applied to other cells.

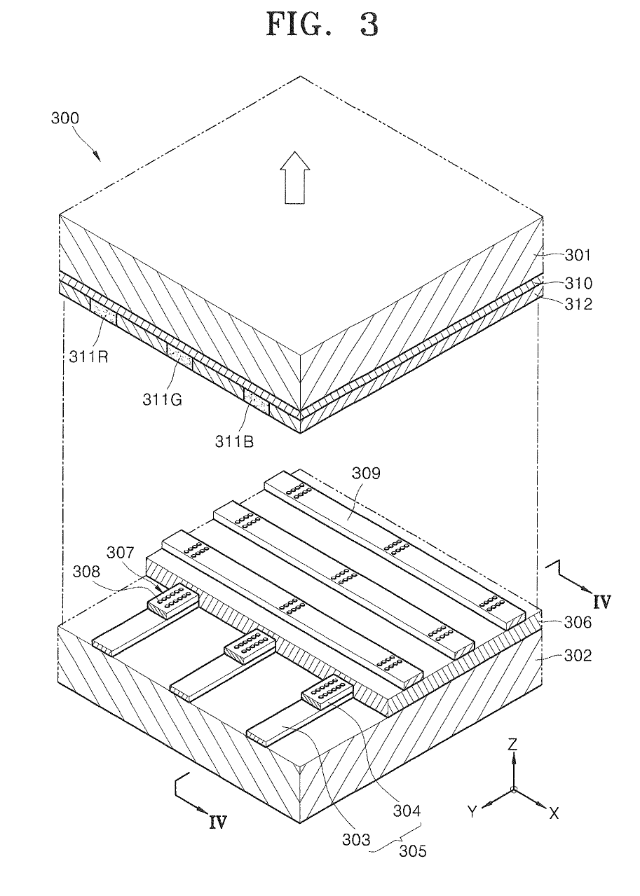

FIG. 3 is a partial perspective view of a display device 300 having electron emission sources 308, according to an embodiment of the present invention.

Referring to FIG. 3, the display device 300 includes first and second substrates 301 and 302, which face each other at a predetermined interval. A structure for displaying a predetermined image by using electrons emitted to an internal space of the display device 300 is formed on the first substrate 301 and a structure for field emission is formed on the second substrate 302.

A plurality of first electrodes 305, each including a transparent electrode 303 and a metal electrode 304 that is electrically connected to the transparent electrode 303, are formed on an inner surface of the second substrate 302.

The transparent electrodes 303 are formed in stripe shapes and are linearly patterned extending in one direction on the second substrate 302. The transparent electrodes 303 may be indium-tin-oxide (ITO) films or indium-zinc-oxide (IZO) films.

The metal electrodes 304 are respectively patterned on the transparent electrodes 303. The metal electrodes 304 are formed in stripe shapes and are linearly patterned on the second substrate 302 to extend in the same direction in which the transparent electrodes 303 are linearly patterned. The metal electrodes 304 may be conductive metal films formed of, for example, a metallic material including chrome (Cr) or silver (Ag) paste.

The first electrodes 305, including the transparent electrodes 303 and the metal electrodes 304 which are electrically connected to the transparent electrodes 303 by overlapping at least portions of the transparent electrodes 303, function as data electrodes. According to the current embodiment, the first electrodes 305 have double layers formed by stacking the transparent electrodes 303 and the metal electrodes 304. However, the present invention is not limited thereto. The first electrodes 305 may have single layers formed of one of the transparent electrodes 303 and the metal electrodes 304. According to another embodiment of the present invention, the first electrodes 305 may have triple layers by adding another type of conductive metal films to the transparent electrodes 303 and the metal electrodes 304.

An insulation layer 306 is formed on the second substrate 302 on which the first electrodes 305 are formed, and thus, the first electrodes 305 are covered by the insulation layer 306. In this case, a plurality of electron emission holes 307 is formed in the first electrodes 305 by also removing portions of the insulation layer 306. The electron emission sources 308 are respectively formed inside the electron emission holes 307.

The electron emission holes 307 are formed in the first electrodes 305 through the removed portions of the insulation layer 306, and thus, the insulation layer 306 is formed to cover an area corresponding to that of the second substrate 302 and to have a sufficient thickness for insulation. The insulation layer 306 is formed of a silicon-oxide-based or silicon-nitride-based material.

A plurality of second electrodes 309, functioning as scan electrodes, is formed on an upper surface of the insulation layer 306. The second electrodes 309 are formed in stripe shapes and are linearly patterned extending in another direction on the second substrate 302. The second electrodes 309 may be disposed so as to cross the first electrodes 305 and regions where the first and second electrodes 305 and 309 cross each other may be defined as sub-pixel regions. Portions of the second electrodes 309 are removed from positions corresponding to the removed portions of the insulation layer 306, so as to expose the electron emission holes 307.

The second electrodes 309 may be transparent conductive films such as ITO films or IZO films, or may be conductive metal films formed of molybdenum (Mo), titanium (Ti), Cr, nickel (Ni), tungsten (W), or Ag.

Meanwhile, the pattern of the first electrodes 305, the insulation layer 306, and the second electrodes 309 is not limited the above-described structure. The first electrodes 305, the insulation layer 306, and the second electrodes 309 may be formed in various patterns.

A third electrode 310, to which a high voltage, for example, 1˜5 kV, is applied, and which is required for accelerating electrons emitted from the electron emission sources 308, may be further formed on an inner surface of the first substrate 301 which faces the second substrate 302. The third electrode 310 functions as an anode electrode. The third electrode 310 is formed of a transparent conductive film such as an ITO film in consideration of an aperture ratio.

A plurality of red, green, blue emission layers 311R, 311G, and 311B, which are excited by electrons emitted from the electron emission sources 308 so as to emit visual light, are formed on a lower (or inner) surface of the third electrode 310. The red, green, blue emission layers 311R, 311G, and 311B are formed on regions respectively corresponding to the regions on which the electron emission sources 308 are formed. A plurality of black matrix layers 312 may be formed between the red, green, blue emission layers 311R, 311G, and 311B in order to improve contrast.

Meanwhile, a plurality of spacers (not shown) may be disposed between the first and second substrates 301 and 302 in order to maintain a uniform gap between the first and second substrates 301 and 302 even in a vacuum state.

Also, a gas is injected into the internal space sealed between the first and second substrates 301 and 302. The gas may be a mixed gas composed by mixing xenon (Xe) with at least one of neon (Ne), helium (He), and argon (Ar).

In this case, any gas may be applied as long as the gas may generate vacuum ultraviolet light by using the emitted electrons from the electron emission sources 308. That is, in addition to a gas including Xe, various gases such as nitrogen (N₂), heavy hydrogen, carbon dioxide (CO₂), a hydrogen (H) gas, carbon monoxide (CO₁), and krypton (Kr), or an atmospheric gas may be used.

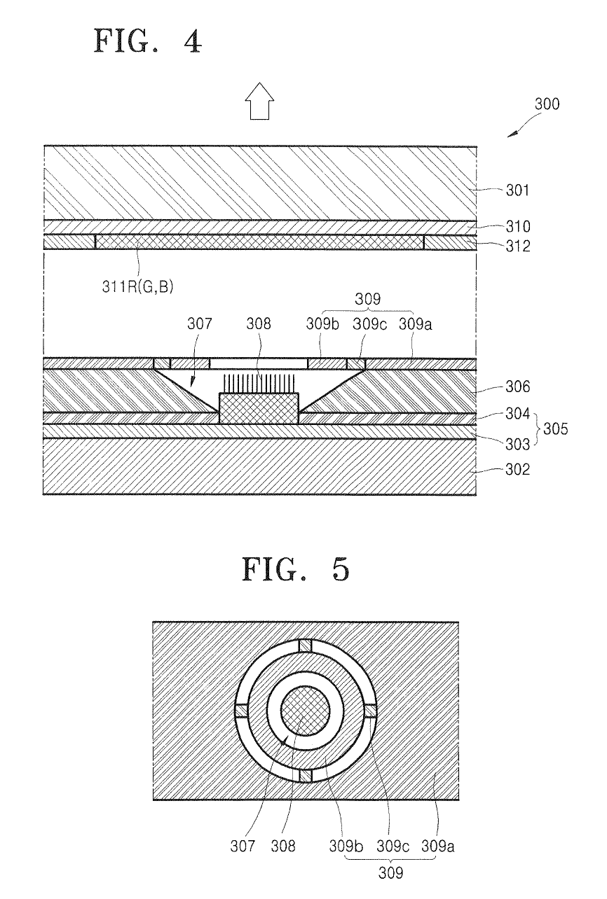

Here, a resistance unit 309c (refer to FIG. 4) is disposed in the second electrodes 309 in order to block a current source of a cell if an over-current flows through the cell. The resistance unit 309c will now be described in detail.

FIG. 4 is a magnified cross-sectional view of the display device 300 which is illustrated in FIG. 3 and which is taken along a line IV-IV, according to an embodiment of the present invention.

Referring to FIG. 4, one of the electron emission holes 307 is formed in a sub-pixel region, that is, a sub-pixel, where the first and second electrodes 305 and 309 cross each other. In this case, the sub-pixel is one of the red, green, and blue emission layers 311R, 311G, and 311B. A pixel is composed of three sub-pixels including the red, green, and blue emission layers 311R, 311G, and 311B.

Electrons may be emitted from a region where the electron emission hole 307 is formed and the electron emission holes 307 may be formed on each sub-pixel. The electron emission hole 307 is formed by perforating the metal electrode 304, the insulation layer 306, and the second electrode 309. The electron emission hole 307 has a circular cross section. However, the present invention is not limited thereto, and thus, the electron emission hole 307 may have various cross sections such as oval and polygonal cross sections.

In this case, the electron emission source 308 is formed in the electron emission hole 307. The electron emission source 308 can be formed in a shape corresponding to a shape of the cross section of the electron emission hole 307. For example, if the electron emission hole 307 has a rectangular cross section, the electron emission source 308 may also have a shape of a rectangular cross section. However, the present invention is not limited thereto, and thus, according to another embodiment of the present invention, the electron emission hole 307 and the electron emission source 308 may respectively have different cross-sectional shapes.

The electron emission source 308 is directly formed on a top surface of the transparent electrode 303. According to another embodiment of the present invention, the metal electrode 304 may be formed in the electron emission hole 307 so as to cover the top surface of the transparent electrode 303, and then, the electron emission source 308 is formed on the top surface of the metal electrode 304 so as to be electrically connected to the metal electrode 304.

The electron emission source 308 may be formed of a material that emits electrons if an electric voltage is applied to the first electrode 305 in a vacuum state, for example, a carbon-based material such as carbon nano tubes (CNTs), graphite, and graphite nano fibers, or a nanometer-sized material such as silicon nano wires.

If the carbon-based material or the nanometer-sized material is used as the electron emission source 308, the electron emission source 308 may be chemically stable, structurally strong, and thermally stable. Also, a temperature for firing may increase and the firing can be conducted in the air. Furthermore, a compound of the carbon-based material or the nanometer-sized material is not distorted and surface defects are reduced. Accordingly, the conductivity and an electron emitting characteristic of the electron emission source 308 may be improved.

In this case, the second electrode 309 includes a second main electrode 309a, a second auxiliary electrode 309b, and the resistance unit 309c.

FIG. 5 is a top view of an electrode unit of the display device 300 illustrated in FIG. 4, according to an embodiment of the present invention.

Referring to FIG. 5, a portion of a second main electrode 309a is removed so as to form an opening that is aligned with the electron emission hole 307. The electron emission hole 307 has a circular cross section in the present embodiment. The second main electrode 309a is formed on an upper surface of the insulation layer 306 illustrated in FIG. 4 in a direction crossing the first electrode 305 illustrated in FIG. 4, as described above in relation to FIGS. 3 and 4.

The second auxiliary electrode 309b is formed in the opening of the second main electrode 309a. The second auxiliary electrode 309b is formed in a region where the electron emission hole 307 is formed, and is disposed above and in parallel with a surface on which the electron emission source 308 is disposed. The size of the region of second auxiliary electrode 309b may be relatively smaller than the size of the region where the electron emission hole 307 is formed.

The second auxiliary electrode 309b may be formed in an open loop shape or a closed loop shape. According to the current embodiment, the second auxiliary electrode 309b is formed in a ring shape. An inner radius of the second auxiliary electrode 309b is formed to be larger than an outer radius of the electron emission source 308. Thus, if the second auxiliary electrode 309b is separated apart from the second main electrode 309a due to an over-current and falls downward, the second auxiliary electrode 309b may fall outside of the electron emission source 308.

Meanwhile, the second main electrode 309a and the second auxiliary electrode 309b may be composed of the same material.

In this case, a plurality of pieces of the resistance unit 309c are formed between the second main electrode 309a and the second auxiliary electrode 309b in order to electrically connect the second main electrode 309a to the second auxiliary electrode 309b. The pieces of the resistance unit 309c are disposed in one or more regions along a boundary of the opening of the second main electrode 309a and along an outer boundary of the second auxiliary electrode 309b so as to electrically connect the second main electrode 309a to the second auxiliary electrode 309b.

The pieces of the resistance unit 309c may be formed of the same material as the material of the second main electrode 309a and the second auxiliary electrode 309b. According to another embodiment of the present invention, a different material may be used.

If the second main electrode 309a, the second auxiliary electrode 309b, and the pieces of the resistance unit 309c are formed of the same material, the pieces of the resistance unit 309c may be formed so as to have a minimized thickness or width. Accordingly, when an over-current flows, the current may be concentrated on the pieces of the resistance unit 309c, and thus the pieces of the resistance unit 309c may fuse due to resistance heat, and break before any portions of the second main electrode 309a and the second auxiliary electrode 309b break. The thickness or width of the resistance unit 309c may be controlled in accordance with an applied current and the sizes of the second main electrode 309a and the second auxiliary electrode 309b.

If the pieces of the resistance unit 309c are formed of a different material from the material of the second main electrode 309a and the second auxiliary electrode 309b, the pieces of the resistance unit 309c may be formed of any metallic material as long as the metallic material has a higher resistance value and a lower melting point than the material of the second main electrode 309a and the second auxiliary electrode 309b so as to enable the pieces of the resistance unit 309c to function as a fuse.

As described above, if an over-current flows, the pieces of the resistance unit 309c break. When a normal current flows, the pieces of the resistance unit 309c properly supplies the normal current.

According to the current embodiment, the pieces of the resistance unit 309c are formed in one or more regions between the second main electrode 309a and the second auxiliary electrode 309b. However, the present invention is not limited thereto. According to another embodiment of the present invention, the resistance unit 309c may cover a whole region between the second main electrode 309a and the second auxiliary electrode 309b so as to connect the second main electrode 309a to the second auxiliary electrode 309b. In this case, the resistance unit 309c may be formed of a transparent conductive material in order to improve an aperture ratio, and any transparent conductive material may be used as long as the thickness of the transparent conductive material may be controlled so that the transparent conductive material may fuse before the material of the second main electrode 309a and the second auxiliary electrode 309b break if an over-current flows.

Operations of the display device 300 described above in relation to FIGS. 3 and 5 will now be described with reference to FIGS. 3 through 5.

If a predetermined voltage is applied between the first and second electrodes 305 and 309, and a high voltage required for accelerating electrons is applied to the third electrode 310, the display device 300 displays an image.

That is, when a “−” voltage of several through several tens of volts (V) is applied to the first electrodes 305, a “+” voltage of several through several tens of V is applied to the second electrodes 309, and a “+” voltage of one through five kilovolts (kV) is applied to the third electrode 310, and thus, an electric field is formed between the first and second electrodes 305 and 309, and electrons are emitted from the electron emission sources 308.

The electrons emitted from the electron emission sources 308 collide with Xe gas included in the internal space between the first and second substrate 301 and 302, and generate vacuum ultraviolet light. The vacuum ultraviolet light collides with the red, green, and blue emission layers 311R, 311G, and 311B so as to emit visual light. Thus, a desired number, character, or graphic image is displayed.

In this case, referring to FIG. 5, if an over-current flows in the electron emission hole 307, the current is concentrated on the resistance unit 309c disposed between the second main electrode 309a and the second auxiliary electrode 309b, the resistance unit 309c fuses due to resistance heat, and the second main electrode 309a and the second auxiliary electrode 309b are electrically disconnected.

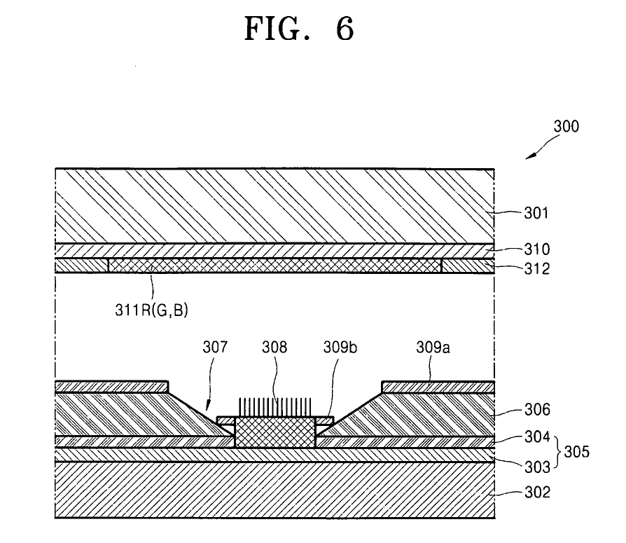

FIG. 6 is a magnified cross-sectional view of the display device 300 illustrated in FIG. 3, after the electrode unit illustrated in FIG. 4 is broken, according to an embodiment of the present invention.

Referring to FIG. 6, if the second main electrode 309a and the second auxiliary electrode 309b are electrically disconnected, the second auxiliary electrode 309b falls to a bottom of the electron emission hole 307. The second auxiliary electrode 309b falls outside of the electron emission hole 307 and thus does not interrupt proceeding routes of electrons emitted from the electron emission source 308.

As such, if an over-current flows in a predetermined defective cell and thus a resistance unit 309c operates, only a current source of the corresponding defective cell may be blocked and other neighboring cells may normally operate. Accordingly, the reliability of the display device 300 may be improved.

As described above, a display device having electron emission sources according to the present invention have the advantages as follows.

First, by disposing resistance units between main electrodes and auxiliary electrodes of second electrodes, if an over-current flows in a predetermined cell, a corresponding resistance unit is fused due to resistance heat and thus an electrical short is caused between corresponding main and auxiliary electrodes. Therefore, a current source may be blocked only in the corresponding cell.

Second, by automatically blocking only a defective cell, every other cell may normally operate and thus the reliability of a display device may be improved.

While the present invention has been particularly shown and described with reference to exemplary embodiments thereof, it will be understood by one of ordinary skill in the art that various changes in form and details may be made therein without departing from the spirit and scope of the invention as defined by the appended claims. The exemplary embodiments should be considered in a descriptive sense only and not for purposes of limitation. Therefore, the scope of the invention is defined not by the detailed description of the invention but by the appended claims, and all differences within the scope will be construed as being included in the present invention.

What is claimed is:

1. A display device having an electron emission source, the display device comprising:
a first substrate; and
a second substrate facing the first substrate;
a first electrode disposed between the first and second substrates;
a second electrode disposed between the first electrode and the first substrate, the second electrode comprising:
a second main electrode;
a second auxiliary electrode; and
a resistance unit connecting the second auxiliary electrode to the second main electrode;
an insulation layer disposed between the first and second electrodes, the insulation layer having an electron emission hole, the second electrode having an opening that is aligned with the electron emission hole;
an electron emission source formed inside the electron emission hole, the electron emission source emitting electrons; and
a gas filling a space formed between the first and second substrates.

2. The display device of claim 1, wherein the opening is formed on the second main electrode, and the second auxiliary electrode is disposed in the opening.

3. The display device of claim 2, wherein a size of the second auxiliary electrode is smaller than a size of the electron emission hole.

4. The display device of claim 2, wherein the second auxiliary electrode is disposed above and in parallel with a surface on which the electron emission source are formed.

5. The display device of claim 2, wherein the second auxiliary electrode is formed in an open loop shape or a closed loop shape.

6. The display device of claim 5, wherein an inner radius of the second auxiliary electrode is larger than an outer radius of the electron emission source.

7. The display device of claim 2, wherein the resistance unit is formed in at least one region between the second main electrode and the second auxiliary electrode so as to connect the second main electrode to the second auxiliary electrode.

8. The display device of claim 2, wherein the resistance unit is formed in whole region between the second main electrode and the second auxiliary electrode so as to connect the second main electrode to the second auxiliary electrode.

9. The display device of claim 1, wherein the second main electrode and the second auxiliary electrode are formed of the same material.

10. The display device of claim 1, wherein the resistance unit is formed of the same material as the second main electrode or the second auxiliary electrode.

11. The display device of claim 1, wherein the resistance unit is formed of a conductive material having a higher resistance value and a lower melting point than materials of the second main electrode and the second auxiliary electrode.

12. The display device of claim 1, wherein a region where the second electrode crosses the first electrode defines a sub-pixel, and one or more electron emission holes are formed in the sub-pixel.

13. The display device of claim 1, further comprising a third electrode formed on an inner surface of the first substrate as an anode electrode, wherein the first electrode is a data electrode which is disposed on an inner surface of the second substrate and extends in a direction, and the second electrode is a scan electrode which extends in another direction crossing the first electrode.

14. The display device of claim 1, wherein the electron emission source is electrically connected to a surface of the first electrode.

15. The display device of claim 1, wherein the electron emission source includes a material selected from a group consisting of carbon nano tubes (CNTs), graphite, graphite nano fibers, diamond, and silicon nano wires.

16. The display device of claim 1, wherein the gas includes a material selected from a group consisting of xenon (Xe), nitrogen (N₂), heavy hydrogen, carbon dioxide (CO₂), a hydrogen (H) gas, carbon monoxide (CO₁), and krypton (Kr).
